(19) United States
(12) Patent Application Publication
(10) Pub. No.: US 2008/0310283 A1
(43) Pub. Date: Dec. 18, 2008

(54) Method of Reading Out Information from a Multiple Layer Optical Recording Medium and Optical Readout Device

(75) Inventors: Johanes De Wit, Helmond (NL); Joris Vrehen, Eindhoven (NL); Sjoerd Stallinga, Eindhoven (NL)

Correspondence Address: BAINWOOD HUANG & ASSOCIATES LLC, 2 CONNECTOR ROAD, WESTBOROUGH, MA, 01581, US

(73) Assignee: ARIMA DEVICES CORPORATION, Road Town, Tortola (VG)

(21) Appl. No.: 11/995,236

(22) PCT Filed: Jul. 10, 2006
(86) PCT No.: PCT/IB2006/052326

§ 371 Date: Feb. 28, 2008

(30) Foreign Application Priority Data
Jul. 13, 2005 (EP) 05300587.2

(51) Int. Cl. G11B 7/00

(52) U.S. Cl. 369/112.05; G9B/7

(57) ABSTRACT

The present invention relates to a method of reading out information from a multiple layer optical recording medium (10) by an optical readout device (12), the method comprising the steps of: focusing a central light beam (14) and two satellite light beams (16, 18) onto a first recording layer (20) of the optical recording medium, projecting reflection beams (22, 24) of at least part of the satellite light beams on two split detectors (26, 28), thereby creating satellite spots (116, 118), each split detector being associated with one of the satellite light beams, the reflected light interfering with light reflected by a second recording layer (21), and processing the signals from the split detectors for providing a tracking error signal, wherein the influence of a central part (29) of the reflection beams on the tracking error signal is removed and/or modified, thereby reducing a negative influence of this central part on the quality of the tracking error signal. The present invention further relates to an optical readout device (12) and to a grating (3Oe) for use in an optical readout device (12).

### FIELD OF THE INVENTION

The present invention relates to a method of reading out information from a multiple layer optical recording medium and to an optical read out device for performing such a method. The present invention particularly relates to cross talk reduction during the readout of a multiple layer optical recording medium.

### BACKGROUND OF THE INVENTION

In the readout of multiple layer optical discs, particularly dual layer discs for the BD or DVD format, problems related to the tracking system are known. In an optical disc drive having an astigmatic focusing system and a three spots push pull (3 spots PP) tracking system light is focused on one of the layers of the dual layer disc. However, a part of the light will be reflected by the other layer. In the detector planes, this light reflected by the other layer forms a big spot that covers the central detector and the satellite detectors. Since the intensity of the big spot on the detector is of the same order of magnitude as the intensity of the satellite spots, a strong interference will occur between the light of the big spot and the light of the satellite spots. The intensity of the interference fringes will change rapidly with small variations in the thickness of the spacer layer between the recording layers. These rapid changes in the interference pattern cause rapid changes in the push pull (PP) signal of the satellite spots. Consequently, the 3 spots PP signal will be destroyed. It is therefore an object of the invention to provide a method and a device that are able to reduce the influence of the second layer reflection on the tracking error signal.

### SUMMARY OF THE INVENTION

The above objects are solved by the features of the independent claims. Further developments and preferred embodiments of the invention are outlined in the dependent claims.

In accordance with the invention, there is provided a method of reading out information from a multiple layer optical recording medium by an optical readout device, the method comprising the steps of:

focusing a central light beam and two satellite light beams onto a first recording layer of the optical recording medium,

projecting reflection beams of at least part of the satellite light beams on two split detectors, thereby creating satellite spots, each split detector being associated with one of the satellite light beams, the reflected light interfering with light reflected by a second recording layer, and

processing the signals from the split detectors for providing a tracking error signal,

wherein the influence of a central part of the reflection beams on the tracking error signal is removed and/or modified, thereby reducing a negative influence of this central part on the quality of the tracking error signal.

The typical interference pattern caused by the interference of the satellite beams with the reflection from the second recording layer is asymmetric due to the astigmatism of the focusing system. When the intensity of the interference fringes changes near the center of the split satellite detectors, the asymmetric intensity pattern will largely change. This leads to large variations in the push pull signal of the satellite spots. On the basis of the invention, the influence of the central part on the tracking error is removed and/or modified, such that the tracking error signal is not destroyed by the interference of the satellite beams with the second layer reflection.

According to an advantageous embodiment, the influence of a central part of the reflection beams on the tracking error signal is removed and/or modified by removing the central part from the satellite spots. Consequently, the influence of these central parts is removed.

This can be, for example, achieved by a method wherein the influence of a central part of the reflection beams on the tracking error signal is removed and/or modified by projecting the central part of the beam into another direction than the rest of the beam by means of a modified central part of a grating. A grating can be provided that reflects different parts of a beam into different directions. For example, the grating can be modified in a way that the central part of the beam is differently deflected than the rest of the beam, for example due to a different distance of the grating lines in the central part of the grating or due to different line orientation.

According to a further embodiment, the influence of a central part of the reflection beams on the tracking error signal is removed and/or modified by covering a central part of the detector by a non-transparent cover.

It is also possible that the influence of a central part of the reflection beams on the tracking error signal is removed and/or modified by choosing an inactive central detector region.

According to a still further embodiment the influence of a central part of the reflection beams on the tracking error signal is removed and/or modified by covering a central part of the detector by a cover that is non-transparent only for particular wavelengths.

Another possibility is that the influence of a central part of the reflection beams on the tracking error signal is removed and/or modified by providing separate detector segments as a central part of the detector, and processing the signals from these separate detector segments differently from the remaining detector segments. While the embodiments mentioned so far operate on the optical side of the detector, according to the present embodiment it is also possible to remove the influence of the central part of the reflection beam by the signal processing.

For example, the influence of a central part of the reflection beams on the tracking error signal is removed and/or modified by providing separate detector segments as a central part of the detector, and not processing the signals from these separate detector segments.

Besides removing the central part of the beam, it is also possible that the influence of a central part of the reflection beams on the tracking error signal is removed and/or modified by modifying the phases of different areas of the central part differently by means of a grating. In this way, the phase of the central part can be “randomized”. Some areas of the grating lead to a phase difference of π relative to other areas of the grating.

As regards the generation of a practicable tracking error signal, it is suggested that the influence of a central part of the reflection beams on the tracking error signal is removed and/or modified by projecting the central part of the beam into another direction than the rest of the beam by means of a modified central part of a grating, the method comprising the further steps of:

projecting the central light beam and the satellite light beam onto the same track of the recording medium, and

using the formula

3spPP=PPc+K/2(PPa+PPb)

for calculating the 3 spots Push Pull signal (3spPP) from the push pull (PP) signals of the satellite light beams (PPa, PPb) and from the PP signal of the central light beam (PPc), wherein K is a constant. Normally, the central spot is positioned on the track and the satellite spots are positioned between the tracks. When the objective lens moves, the three spots on the three detectors move into the same direction (“beam landing”), resulting in offsets of the separate PP signals having the same sign. Hence, the following formula is normally used:

3spPP=PPc−K/2(PPa+PPb) (1).

Thereby, the beam landing effect will be compensated. Thus, the beam landing effect will not negatively influence the desired modulation of the 3 spots PP signal. Now, with a grating having a modified central part, the offset of the satellite spots has the opposite sign as compared to the offset of the central spot. Consequently, rather than formula (1), the following formula is used:

3spPP=PPc+K/2(PPa+PPb) (2).

Thereby, the beam landing is compensated. However, with the central spot on the track and the satellite spots between the tracks and the related phase difference of 180 degrees, formula (2) would not generate a practicable 3 spots PP signal. The solution is to remove the phase difference by positioning also the satellite spots on the track, rather than between the tracks. As in the normal case, this leads to a 3 spots PP signal that is twice the PP signal of the central spot.

In accordance with the invention, there is further provided an optical readout device for reading out information from a multiple layer optical recording medium, the optical readout device comprising:

means for focusing a central light beam and two satellite light beams onto a first recording layer of the optical recording medium,

means for projecting reflection beams of at least part of the satellite light beams on two split detectors, thereby creating satellite spots, each split detector being associated with one of the satellite light beams, the reflected light interfering with light reflected by a second recording layer,

means for processing the signals from the split detectors for providing a tracking error signal, and

means for removing and/or modifying the influence of a central part of the reflection beams on the tracking error signal, thereby reducing a negative influence of this central part on the quality of the tracking error signal.

For example, the means for projecting and the means for removing and/or modifying comprise a grating.

According to a preferred embodiment of the present invention the means for projecting and the means for removing and/or modifying comprise a grating, the grating having a central region with lines perpendicular to the lines of outer regions. Therefore, the light passing the central region is projected into a direction perpendicular to the line through the satellite spots and the central spot.

Further, it is possible that the means for projecting and the means for removing and/or modifying comprise a grating, the grating having a central region with lines having a different distance to each other than the lines of outer regions. By choosing the distance between the grating lined and the central region smaller than in the outer regions, the deflection angle of the light in the central region can be much larger than that of the outer regions.

According to a further embodiment, the means for projecting and the means for removing and/or modifying comprise a grating, the grating having a central region without lines. On the basis of such a flat central region, the central spot on the detector can have a higher intensity, because only a part of the beam is covered by the grating. In order to have a flat wavefront in the central spot, the middle area should have a certain height compared to the grooved area, namely half the height of the grooved area.

According to a further embodiment, the means for projecting and the means for removing and/or modifying comprise a grating, the grating having a central region with lines that are shifted by half the distance between the lines, thereby providing means for modifying the phases of different areas of the central part differently. In this way, the randomizing of the central part can be achieved.

It is also possible that the means for removing and/or modifying comprise covers covering the central part of the split detectors.

Further, it can be advantageous that the means for removing and/or modifying comprise a dichroic coating covering the central part of the split detectors.

According to a still further embodiment, each split detector comprises separate detector segments as a central part of the detector, the signals of which can be processed differently from the signals generated from outer detector segments.

For example, each split detector comprises separate detector segments as a central part of the detector, the signals of which are not used for generating the tracking error signal.

According to a still further embodiment of the present invention an optical readout device is provided, wherein the means for projecting and the means for removing and/or modifying comprise a grating,

the grating comprises of a plurality of zones having zone boundaries between adjacent zones,

within a zone a plurality of alternating high and low regions are extending along straight parallel lines over the grating surface, the high and low regions having a constant width in a direction perpendicular to the straight parallel lines, and

at the zone boundaries two adjacent regions are either two high regions or two low regions,

thereby separating a satellite light beam into two twin-spots on the first recording layer.

The grating is divided in straight zones having boundaries between these zones. At such a zone boundary, the grating profile makes a face jump of π. A conventional grating has a cross-section consisting of alternating high and low regions of fixed and equal widths. In the proposed grating the width of the high or low region at the zone boundary is doubled. On the basis of such a grating, the satellite spots consist of two sub-spots or twin-spots with a small separation. As a consequence, the interference pattern on the satellite detectors is modified. Interference patterns in neighboring detector zones that correspond to neighboring zones on a grating, have a fringe pattern opposite to each other. Thus, at a zone boundary a dark fringe becomes bright and a bright fringe becomes dark. In this way the left-right imbalance of the interference pattern can be averaged out.

Preferably, for the width A between two subsequent zone boundaries and the distance B between the optical axis and the nearest zone boundary the following equations apply:

A=nt/((2j−1)sNA)

B=0

wherein j=1, 2, 3, . . . ; t is the distance between the central light beam and the center of the two twin-spots on the first recording layer; n is the refractive index of a spacer layer between the first recording layer and the second recording layer; s is the thickness of the spacer layer between the first recording layer and the second recording layer; and NA is the numerical aperture of the objective lens of the optical readout device. The improvement depends on the zone width A and on the distance B between the beam center, i.e. the optical axis, and the nearest zone boundary. In fact, for some values of A and B the grating gives a better improvement. This is related to the position of the saddle-point of the interference pattern and of the zone boundaries. The optimum suppression occurs, if the saddle-point is at the center of a zone. There are approximate expressions for the parameters A and B available, as mentioned above. Preferably, j is chosen as 1 in order to keep the zone width as large as possible.

According to an alternative embodiment, for the width A between two subsequent zone boundaries and the distance B between the optical axis and the nearest zone boundary the following equations apply:

A=nt/(2jsNA)

B=nt/(4jsNA)

wherein j=1, 2, 3, . . . ; t is the distance between the central light beam and the center of the two twin-spots on the first recording layer; n is the refractive index of a spacer layer between the first recording layer and the second recording layer; s is the thickness of the spacer layer between the first recording layer and the second recording layer; and NA is the numerical aperture of the objective lens of the optical readout device.

The present invention further relates to a grating with a plurality of zones as described above.

These and other aspects of the invention will be apparent from and elucidated with reference to the embodiments described hereinafter.

### BRIEF DESCRIPTION OF THE DRAWINGS

FIG. 1 shows a schematical set up of an optical readout device according to the present invention.

FIG. 2 shows a pattern of light spots in the detector plane.

FIG. 3 shows a schematical representation of a satellite spot on a split detector.

FIG. 4 shows a schematical representation of a satellite spot on a split detector with the central region removed.

FIG. 5 shows a schematical representation of a satellite spot on a split detector with the central region removed and the phase randomized.

FIG. 6 shows a first embodiment of a grating that can be used in accordance with the present invention.

FIG. 7 shows a second embodiment of a grating that can be used in accordance with the present invention.

FIG. 8 shows a third embodiment of a grating that can be used in accordance with the present invention.

FIG. 9 shows an illustration of different regions of a grating that produce phase differences in accordance with the present invention.

FIG. 10 shows grating lines in a central region of a grating in order to generate phase differences in accordance with the present invention.

FIG. 11 shows a top view and a cross-sectional side view of a conventional grating used in optical readout devices.

FIG. 12 shows a top view and a cross-sectional side view of a grating in accordance with the present invention;

FIG. 13 shows an interference pattern typical for a pattern produced on a split detector when a grating in accordance with FIG. 11 is employed.

FIG. 14 shows an interference pattern typical for a pattern produced on a split detector when a grating in accordance with FIG. 12 is employed.

FIG. 15 shows intensity distribution of the satellite spot(s) on the recording layer for a conventional grating in accordance with FIG. 11 and for a grating in accordance with FIG. 12.

FIG. 16 shows the push-pull peak-peak offset as a function of the distance t between the main spot and the satellite spot(s).

FIG. 17 shows a top view of a detector arrangement.

FIG. 18 shows a top view of a modified detector arrangement in accordance with the present invention.

FIG. 19 shows a top view of a further modified detector arrangement in accordance with the present invention.

FIG. 20 shows a top view of a further modified detector arrangement in accordance with the present invention.

FIG. 21 shows a top view of a further modified detector arrangement in accordance with the present invention.

FIG. 22 shows an optical light path diagram for explaining a preferred concept of creating a 3 spots Push Pull signal.

FIG. 23 shows an optical light path diagram for explaining a preferred concept of creating a 3 spots Push Pull signal.

FIG. 24 shows a spilt satellite detector with a satellite spot having a removed central area.

FIG. 25 shows a split satellite detector with a satellite spot having a removed central area upon movement of an objective lens.

### DESCRIPTION OF PREFERRED EMBODIMENTS

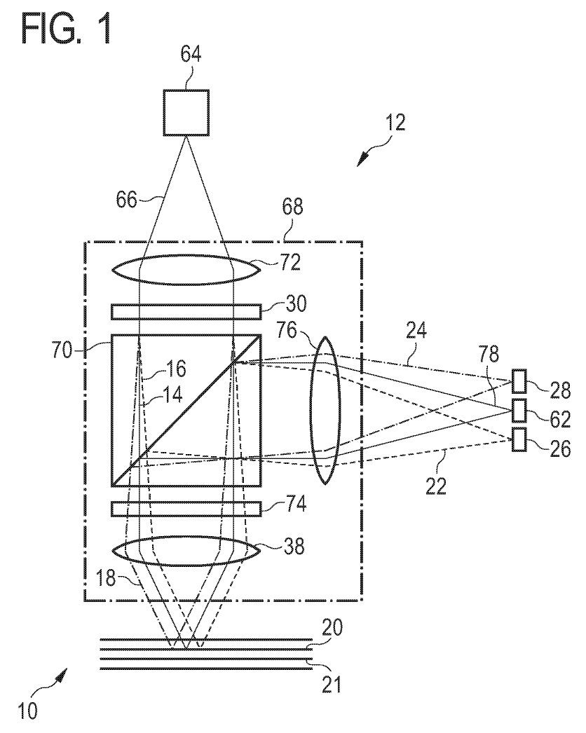

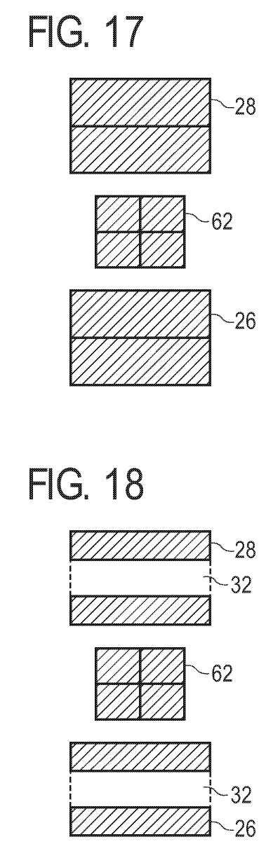

FIG. 1 shows a schematical set up of an optical readout device 12 according to the present invention. A dual layer optical recording medium 10 having a first recording layer 20, a second recording layer 21 and a spacer layer between the recording layers is arranged to rotate in a plane perpendicular to the drawing plane. A light source 64, e.g. a semiconductor laser, emits a laser beam 66. An optical system 68 diffracts and focuses the laser beam 66 to form a central light beam 14 and two satellite light beams 16, 18. The central light beam 14 and the satellite light beams 16, 18 are focused onto one recording layer 20 of the optical recording layer 10 and reflected back to the optical system. The reflected satellite light beams 22, 24 and the reflected central light beam 78 are projected to a detector arrangement 26, 28, 62 that has two satellite split detectors 26, 28 and one split central detector 62 (see for example FIG. 17). In order to realize the described light path, the optical system 68 comprises the following components: a collimator lens 72, a grating 30, a beam splitter 70, a quarter-wave plate 74, an objective lens 38 and a servo lens 76. It is also possible to use a straight light path between the disc and the detector arrangement, while the light path from the light source is coupled in perpendicular to the mentioned straight light path. Further modifications are possible and well known to the one skilled in the art.

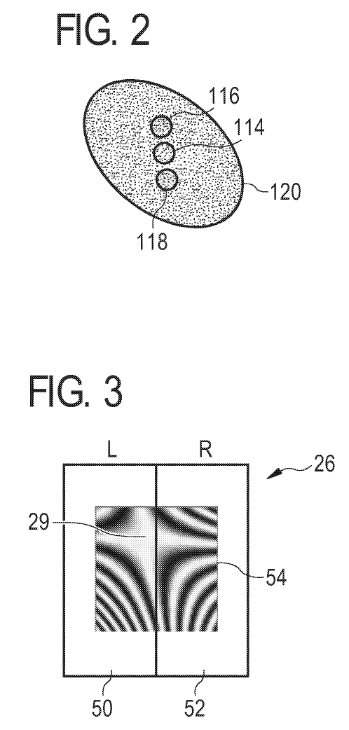

FIG. 2 shows a pattern of light spots in the detector plane. The central spot 114 generated by the central beam 14 (see FIG. 1) has a higher intensity than the satellite spots 116, 118 generated by the beams 16, 18 (see FIG. 1). Additionally, a large spot 120 can be seen that results from the reflection of the readout beam on the second recording layer, i.e. the recording layer onto which the readout beam is not focused. The intensity of the large spot 120 has the same order of magnitude as the intensity of the satellite spots 116, 118. The phase of the light in the large spot 120 as compared to the phase of the light in the satellite spots has an offset of 2 ns/λ wherein n is the refractive index of the cover layer of the disc, s is the spacer thickness, and λ is the wavelength of the light. A strong interference will occur between the light of the large spot 120 and the light of the satellite spots 116, 118. The intensity of the interference fringes will change rapidly with small variations in the spacer thickness. These rapid changes in the interference pattern cause rapid changes in the PP signals of the satellite spots, thus ruining the 3 spots PP signal.

FIG. 3 shows a schematical representation of a satellite spot on a split detector. The split detector 26 comprises two detector segments 50, 52 that provide separate signals. The push pull signal of this detector 26 is defined as the signal from the left detector segment 50 minus the signal of the right detector segment 52. A typical interference pattern 54 is shown. The interference pattern 54 is caused by the interference between the satellite beams and the second layer reflection beam. A typical saddle-shaped bright square near the center of the spot 29 can be seen. This appearance is caused by the astigmatism of the focusing system. The saddle-shaped region 29 makes the intensity pattern of the satellite spots asymmetric. When the intensity of the fringes changes because of changes in the spacer layer thickness between the recording layer, the asymmetric intensity pattern will result in large variations in the push pull signal of the satellite spots. Consequently, the 3 spots PP signal will be destroyed.

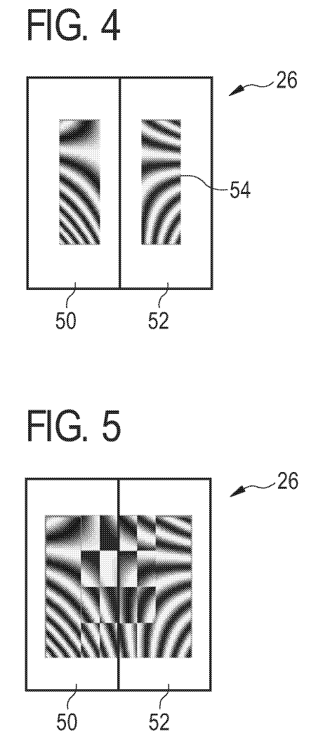

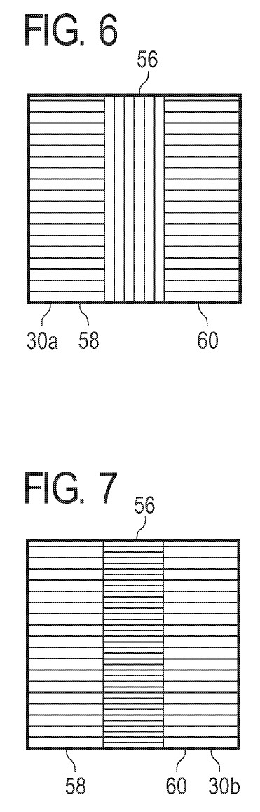

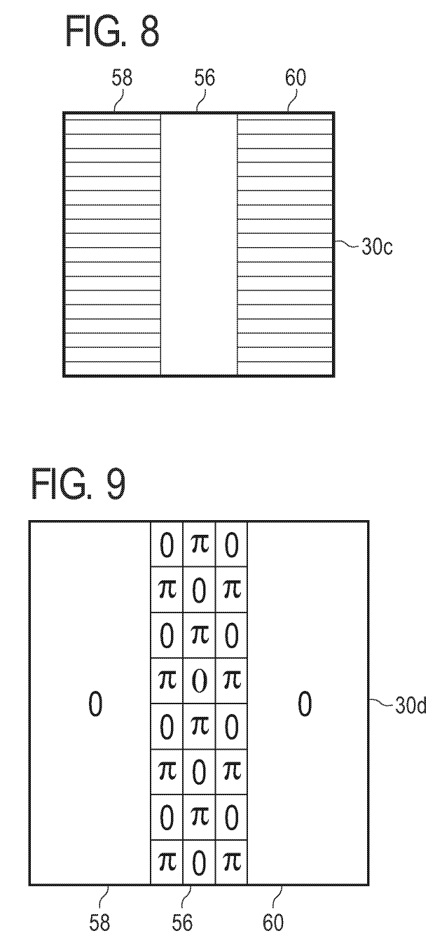

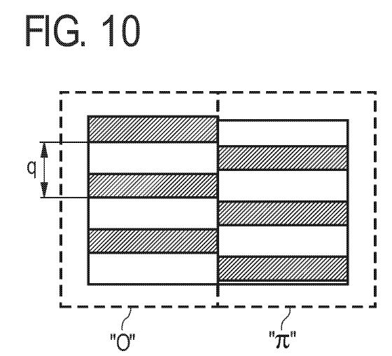

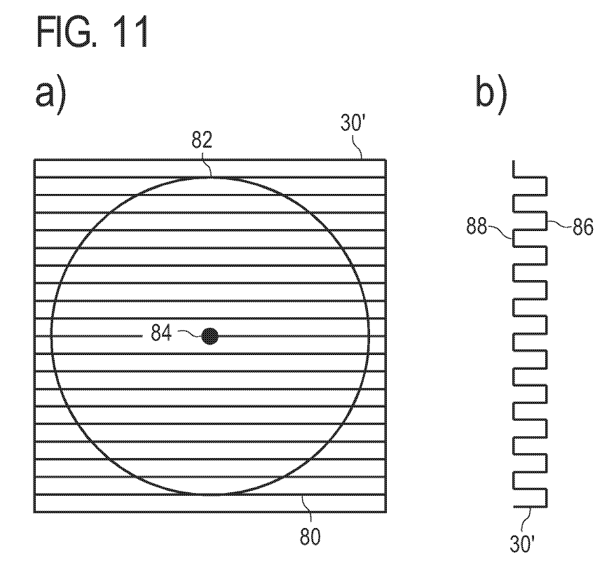

FIG. 4 shows a schematical representation of a satellite spot on a split detector with the central region removed. FIG. 5 shows a schematical representation of a satellite spot on a split detector with the central region removed and the phase randomized. FIG. 6 shows a first embodiment of a grating that can be used in accordance with the present invention. FIG. 7 shows a second embodiment of a grating that can be used in accordance with the present invention. FIG. 8 shows a third embodiment of a grating that can be used in accordance with the present invention. FIG. 9 shows an illustration of different regions of a grating that produce phase differences in accordance with the present invention. FIG. 10 shows grating lines in a central region of a grating in order to generate phase differences in accordance with the present invention. In connection with these Figures different solutions in order to remove the influence of the central part 29 (see FIG. 3) of the interference pattern 54 are described. FIG. 4 shows an interference pattern 54 with a removed central part. This can be achieved by using one of the gratings shown in FIG. 6, 7 or 8 in the portion of the grating 30 according to FIG. 1. The grating 30a according to FIG. 6 directs the light of the central area of the beam into a direction perpendicular to the line through the three spots. This is achieved by giving the grooves in the central area 56 of the grating 30a an angle of 90 degrees compared to the grooves in the outer areas 58, 60 of the grating 30a. According to FIG. 7, a grating 30b is provided that directs the light in the same direction as the line through the three spots, but at a much larger distance, for example to a position located at twice the distance between the main spot and the satellite spot. This is achieved by choosing the distance between the grating lines in a central area 56 of the grating as half of the distance of the lines in the outer areas 58, 60 of the grating 30b. FIG. 8 shows a further possibility in order to remove the central part of the beam. In this grating 30c a flat central area 56 is provided, while the outer areas 58, 60 have grating lines. In order to obtain a flat wavefront in the central spot, the middle area should have certain height compared to the grooved area, namely half the height of the depth of the groove in the outer areas 58, 60. The grating 30c in accordance with FIG. 8 has the advantage, as compared to the gratings 30a and 30b in accordance with FIG. 6 and FIG. 7, that the central spot has a higher power because only part of the beam is covered by the grating 30c.

In connection with FIGS. 9 and 10 a grating is described on the basis of which an interference pattern as shown in FIG. 5 can be achieved, i.e. a “phase randomized” interference pattern. The grating 30d in accordance with FIG. 9 has outer regions 58, 60 and a central region 56 that produce phase differences. All of the regions in which a “0” is shown do not produce a phase difference relative to each other. Similarly, all of the regions, in which a “π” is shown do not produce a phase difference relative to each other. However, the regions showing a “π” have a phase difference of π relative to the regions having a “0”. This can be achieved in accordance with FIG. 10, by shifting the grating lines of the regions by a distance q/2 relative to each other, where q is the distance between the grating lines. Thus, FIG. 10 shows two neighboring segments of a grating, wherein the right part has a phase difference of “π” compared to the left part.

FIG. 11 shows a top view and a cross-sectional side view of a conventional grating used in optical readout devices. The top view (a) of the grating 30′ shows regularly spaced grating lines 80. Further, a beam cross-section 82 and a beam center 84 are indicated. The cross-sectional view (b) of the grating 30′ shows high regions 86 and low regions 88 of the grating surface, by which the regularly spaced grating lines 80 are formed.

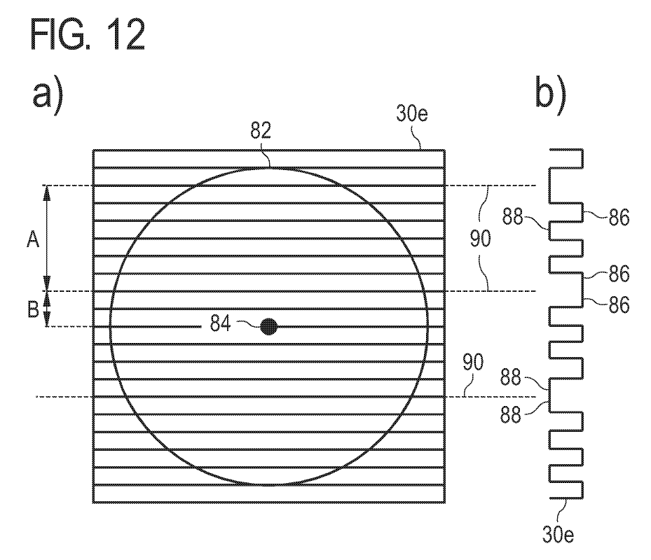

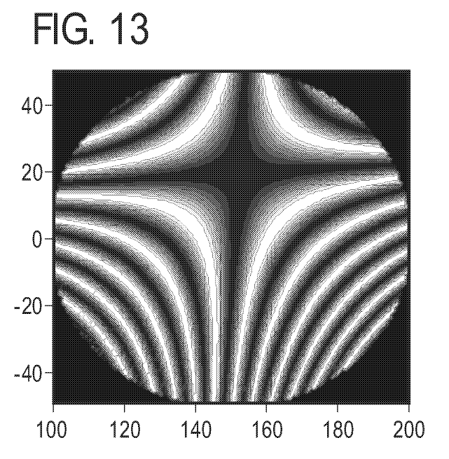

FIG. 12 shows a top view and a cross-sectional side view of a grating in accordance with the present invention. In addition to the elements shown in FIG. 11, the grating 30e in accordance with the present invention comprises of zones that are separated by zone boundaries 90. The zone boundaries 90 are formed, as can be seen in the cross-sectional view (b) of the grating 30e, by two adjacent high regions 86 or by two adjacent low regions 88, thereby providing regions of twice the width of the normal alternating high and low regions. Thereby, a π face-jump is generated at the zone boundaries 90. In FIG. 12, two parameters are indicated namely A, which is the regular distance between the adjacent zone boundaries 90, and B which is the distance between the beam center and the nearest zone boundary 90. These parameters are used for further explanations above and below.

FIG. 13 shows an interference pattern typical for a pattern produced on a split detector when a grating in accordance with FIG. 11 is employed. The indicated interference pattern is similar to the interference pattern as described in connection with FIG. 3. Additionally, coordinates in μm on the detector area are shown. Particularly, the beam center is positioned at 150 μm from the optical axis. As already mentioned, such an interference pattern consists of alternating bright and dark regions resulting in noisy fluctuations on the push-pull signal, the so-called coherent cross-talk. Consequently, an offset of the push-pull signal is experienced.

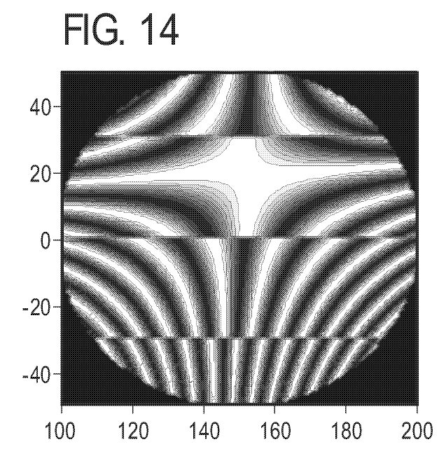

FIG. 14 shows an interference pattern typical for a pattern produced on a split detector when a grating in accordance with FIG. 12 is employed. The interference pattern on the satellite detector shows lines across which the polarity of the fringe pattern changes. In other words, a dark fringe becomes bright when crossing such a line, and a bright fringe becomes dark when crossing such a line. These lines on the detector plane correspond to the zone boundaries (FIG. 12, 90) of the grating (FIG. 12, 30e). In this way, the left-right imbalance on the split detector can be averaged out.

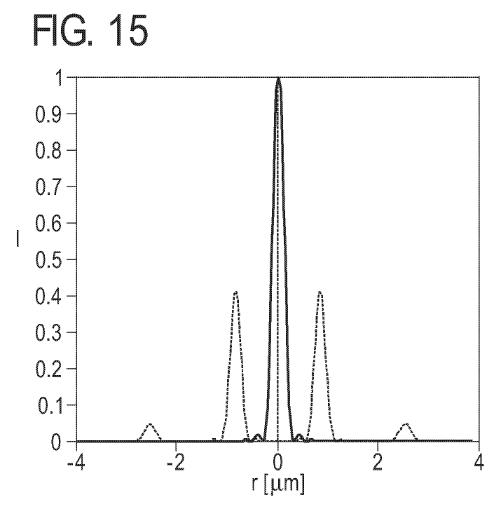

FIG. 15 shows intensity distribution of the satellite spot(s) on the recording layer for a conventional grating in accordance with FIG. 11 and for a grating in accordance with FIG. 12. The radial relative intensity I of the satellite spot(s) on the disc in dependence on the radial coordinate r in μm on the disc is shown for two different cases: the solid line shows the intensity distribution for a conventional grating (see for example FIG. 11), while the dashed line shows the intensity distribution for a grating in accordance with the present invention (see for example FIG. 12). As can be seen, two twin-spots are generated on the basis of the grating in accordance with the present invention, while the separation of the twin-spots depends on the zone width A, as shown in FIG. 12. If A is small, the separation is large.

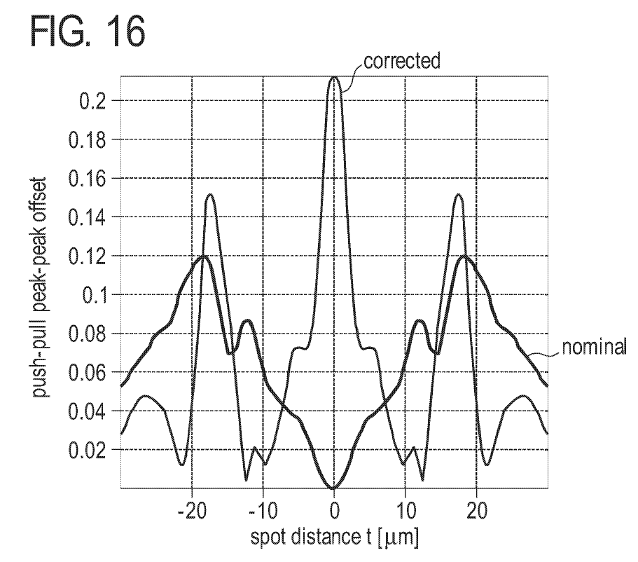

FIG. 16 shows the push-pull peak-peak offset as a function of the distance t between the main spot and the satellite spot(s). The push-pull peak-peak offset for a conventional grating (see for example FIG. 11) is shown by the curve “nominal”, while the push-pull peak-peak offset for a grating according to the present invention is shown as the curve “corrected”. Both offsets are plotted as a function of the spot distance t in μm. The spot distance in the case of the twin-spots is defined as the distance between the main spot and the center of the twin-spots. The parameters A and B (see FIG. 12) are chosen as A=0.65 and B=0.

The offset of the push-pull signal is produced due to the interference of the satellite spots reflected by the recording layer in focus with the spot reflected by the recording layer out of focus. In other words: the satellite spots are assumed to be perfectly centred on the satellite detectors, such that only the intensity imbalance due to interference is concerned.

The symmetrical curves start from the theoretical point having a spot distance of 0 between the main spot and the satellite spots on the disc, i.e. the main spot and the satellite spots coincide. In this theoretical case, the “nominal” push-pull offset is equal to 0. However, for the “corrected” case there is a push-pull offset, since, due to the presence of the twin spots for each satellite spot, also imbalance due to interference is present.

The grating used for the “corrected” case is optimized for a typical spot distance between the main spot and the satellite spots on the disc of about 10 μm. In this optimum suppression case the saddle point of the interference pattern is at the center of a zone. For t=10 μm the push-pull offset for the nominal case is by a factor of three greater than the push-pull offset for the corrected case, hence the push-pull offset suppression works with a factor of three.

FIG. 17 shows a top view of a detector arrangement. Two split satellite detectors 26, 28 and a detector 62 for the central spot can be seen. All of the detectors are able to provide a push pull signal, so that the three push pull signals can be combined to a 3 spots Push Pull signal. The central spot detector 62 has four segments in order to also correct for a focusing error.

FIG. 18 shows a top view of a modified detector arrangement in accordance with the present invention. In accordance with the invention, the central part of the satellite beams can be removed by providing a cover 32 over the central part of the satellite detectors 26, 28. Another possibility is to inactivate the region of the satellite detector 26, 28 that is denoted by reference numeral 32 in FIG. 18.

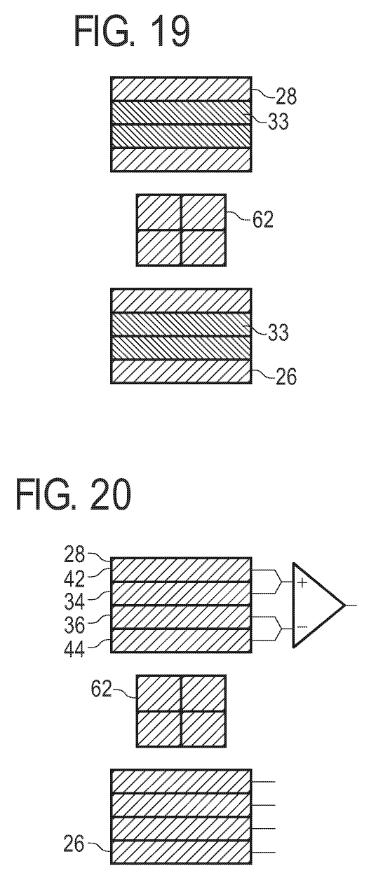

FIG. 19 shows a top view of a further modified detector arrangement in accordance with the present invention. On the central area of the satellite detector 26, 28 a dichroic coating 33 is applied. This coating 33 is transparent for some wavelengths, for instance red and/or infrared for DVD and CD and not transparent for other wavelengths for example the blue light for BD. Thus, in a readout device for different optical recording standards, the central parts of the satellite detectors 26, 28 can be used, for example in the CD case, while in other cases the central parts are not used, for example in case of a double layer BD.

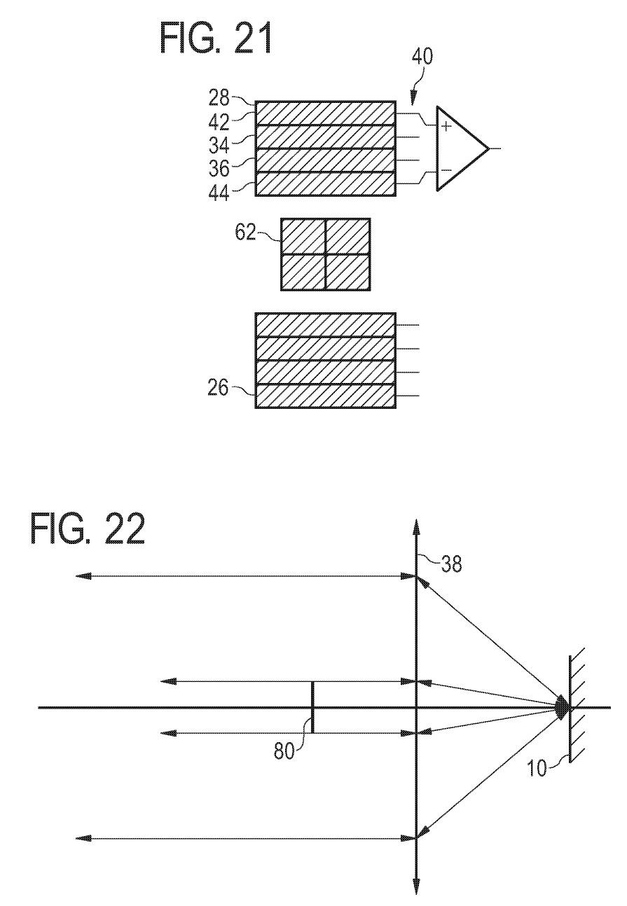

FIGS. 14 and 15 show top views of further modified detector arrangements in accordance with the present invention. Here, the satellite detectors 26, 28 are each divided into four segments. In order to generate the push pull signal, the signals of the two upper segments 34, 32 and of the two lower segments 36, 44 can be used in order to be subtracted from each other (see FIG. 20). According to FIG. 21 the electrical means 40 for processing the signals can be designed such that the signals from the inner segments 34, 36 of the split detectors 28, 26 do not contribute to the push pull signal. It is also possible not to discard the signals from segments 34, 36 completely, but to adapt the means 40 for electrically processing the signals such that an optimum Push Pull signal is obtained.

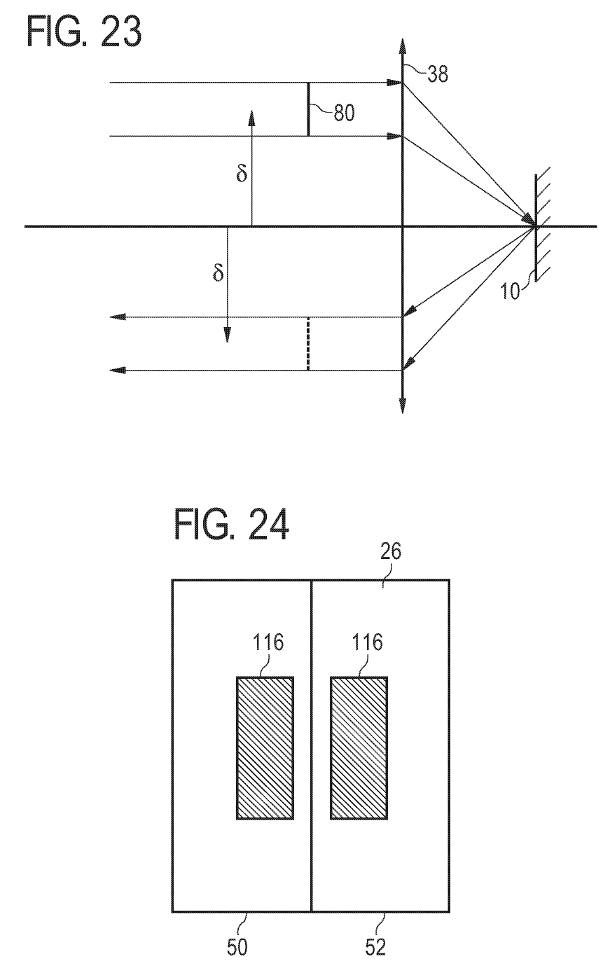

FIG. 22 and FIG. 23 show an optical light path diagram for explaining a preferred concept of creating a 3 spots Push Pull signal.

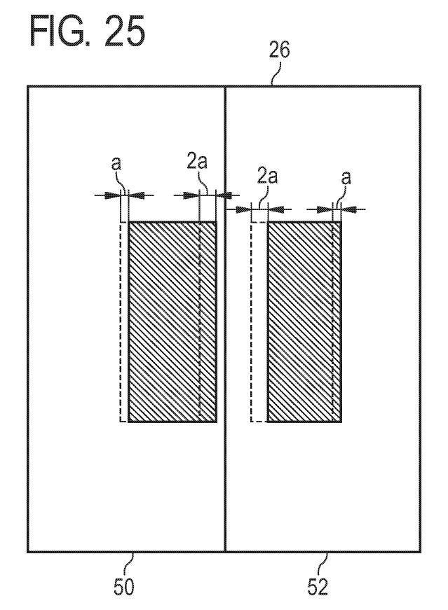

FIG. 24 shows a split satellite detector with a satellite spot having a removed central area.

FIG. 25 shows a split satellite detector with a satellite spot having a removed central area upon movement of an objective lens.

If a three spots grating as shown in FIG. 6, 7 or 8 is used in the light path of an optical pickup device, further considerations as to the calculation of the 3 spots Push Pull signal are necessary. The central part of the grating can be considered as an obscuration 80 in the light path as shown in FIGS. 16 and 17. The FIGS. 16 and 17 further show an objective lens 38 and part of the optical recording medium 10 that generally acts as a mirror. In FIG. 22, the obscuration 80 is centered exactly on the optical axis of the light path. FIG. 23 shows the situation after having moved the objective lens 38 by a distance δ in radial direction. From FIG. 23 it is obvious that in this case the image of the obscuration will move over a distance 26. FIG. 24 shows the position of the satellite spot in the split detector 26 when the grating, i.e. the obscuration in terms of the description of FIGS. 16 and 17, is exactly centered on the light path, as shown in FIG. 22. FIG. 25 corresponds to FIG. 23. It is illustrated that the spots on the left part 50 and the right part 52 of the split detector 26 both shift by a distance “a” when the objective lens made a radial stroke of δ. However, the image of the obscuration moves over a distance “2a”. Consequently, the signal of the left detector segment 50 becomes larger than the signal of the right detector segment 52 resulting in a positive push pull signal that is defined as left signal minus right signal. This is in contrast to the normal situation with an ordinary three spots grating. In this case, the signal in the left half of the detector would become smaller, while the signal on the right half becomes larger, resulting in a negative push pull signal. In this normal case, the following formula is used:

3spPP=PPc−K/2(PPa+PPb) (1),

wherein 3spPP is the 3 spots push pull signal, PPa and PPb are the push pull signals of the satellite detectors and PPc is the push pull signal of the central detector. K is a constant, preferably the grating ratio. This formula works with an ordinary grating in which the central spot is positioned on the track and the satellite spots are positioned between the tracks, considering that the push pull signals of the satellite spots have a phase offset of 180 degrees as compared to the central spot. Thus, when the objective lens moves, the three spots on the three detectors move in the same direction (“beam landing”), resulting in offsets of the separate PP signals having the same sign. Hence, using the above formula, the beam landing effect will be compensated. Thus, the beam landing effect will not negatively influence the desired modulation of the 3 spots PP signal.

Now, with a grating having a modified central part, the offset of the satellite spots has the opposite sign as compared to the offset of the central spot. Consequently, the following formula compensates for the beam landing:

3spPP=PPc+K/2(PPa+PPb) (2).

However, with the central spot on the track and the satellite spots between the tracks and the related phase difference of 180 degrees, this formula (2) would not generate a practicable 3 spots PP signal. The solution is to remove the phase difference by positioning also the satellite spots on the track, rather than between the tracks. As in the normal case, this leads to a 3spots PP signal that is approximately twice the PP signal of the central spot.

Equivalents and modifications not described above may also be employed without departing from the scope of the invention, which is defined in the accompanying claims.

1. A method of reading out information from a multiple layer optical recording medium by an optical readout device, the method comprising the steps of:
focusing a central light beam and two satellite light beams onto a first recording layer of the optical recording medium,
projecting reflection beams of at least part of the satellite light beams on two split detectors, thereby creating satellite spots each split detector being associated with one of the satellite light beams, the reflected light interfering with light reflected by a second recording layer, and
processing the signals from the split detectors for providing a tracking error signal,
wherein the influence of a central part of the reflection beams on the tracking error signal is removed, thereby reducing a negative influence of this central part on the quality of the tracking error signal.

2. The method according to claim 1, wherein the influence of a central part of the reflection beams on the tracking error signal is removed by removing the central part from the satellite spots on the split detectors.

3. The method according to claim 1, wherein the influence of a central part of the reflection beams on the tracking error signal is removed by projecting the central part of the beam into another direction than the rest of the beam by a modified central part of a grating.

4. The method according to claim 1, wherein the influence of a central part of the reflection beams on the tracking error signal is removed by covering a central part of the detector by a non-transparent cover.

5. The method according to claim 1, wherein the influence of a central part of the reflection beams on the tracking error signal is removed by choosing an inactive central detector region.

6. The method according to claim 1, wherein the influence of a central part of the reflection beams on the tracking error signal is removed by covering a central part of the detector by a cover that is non-transparent only for particular wavelengths.

7. The method according to claim 1, wherein the influence of a central part of the reflection beams on the tracking error signal is removed by providing separate detector segments as a central part of the detector, and processing the signals from these separate detector segments differently from the remaining detector segments.

8. The method according to claim 1, wherein the influence of a central part of the reflection beams on the tracking error signal is removed by providing separate detector segments as a central part of the detector, and not processing the signals from these separate detector segments.

9. (canceled)

10. The method according to claim 1, wherein the influence of a central part of the reflection beams on the tracking error signal is removed by projecting the central part of the beam into another direction than the rest of the beam by a modified central part of a grating, the method comprising the further steps of:
projecting the central light beam and the satellite light beam onto the same track of the recording medium, and
using the formula
3spPP=PPc+K/2(PPa+PPb)
for calculating the 3 spots Push Pull signal (3spPP) from the Push Pull (PP) signals of the satellite light beams (PPa, PPb) and from the PP signal of the central light beam (PPc), wherein K is a constant.

11. An optical readout device for reading out information from a multiple layer optical recording medium, the optical readout device comprising:
a component for focusing a central light beam and two satellite light beams onto a first recording layer of the optical recording medium,
a component for projecting reflection beams of at least part of the satellite light beams on two split detectors, thereby creating satellite spots, each split detector being associated with one of the satellite light beams, the reflected light interfering with light reflected by a second recording layer,
a signal processor (40) for processing the signals from the split detectors for providing a tracking error signal, and
a remover for removing the influence of a central part of the reflection beams on the tracking error signal, thereby reducing a negative influence of this central part on the quality of the tracking error signal.

12. The optical readout device according to claim 11, wherein the component for projecting and the remover for removing comprise a grating.

13. The optical readout device according to claim 11, wherein the component for projecting and the remover for removing comprise a grating, the grating having a central region with lines perpendicular to the lines of outer regions.

14. The optical readout device according to claim 11, wherein the component for projecting and the remover for removing comprise a grating, the grating having a central region with lines having a different distance to each other than the lines of outer regions.

15. The optical readout device according to claim 11, wherein the component for projecting and the remover for removing comprise a grating, the grating having a central region without lines.

16. (canceled)

17. The optical readout device according to claim 11, wherein the remover for removing comprises a cover covering the central part of the split detectors.

18. The optical readout device according to claim 11, wherein the remover for removing comprises a dichroic coating covering the central part of the split detectors.

19. The optical readout device according to claim 11, wherein each split detector comprises separate detector segments as a central part of the detector, the signals of which can be processed differently from the signals generated from outer detector segments.

20. The optical readout device according to claim 11, wherein each split detector comprises separate detector segments as a central part of the detector, the signals of which are not used for generating the tracking error signal.

21-26. (canceled)
